(19) United States
(12) Patent Application Publication
(10) Pub. No.: US 2023/0112989 A1
(43) Pub. Date: Apr. 13, 2023

(54) PARTICULATE LAUNDRY COMPOSITION

(71) Applicant: The Procter & Gamble Company, Cincinnati, OH (US)

(72) Inventors: Rui SHEN, Beijing (CN); Pu ZHAO, Beijing (CN)

(21) Appl. No.: 18/080,400

(22) Filed: Dec. 13, 2022

Related U.S. Application Data
(63) Continuation of application No. PCT/CN2020/100132, filed on Jul. 3, 2020.

(51) Int. Cl. C11D 3/50; C11D 11/00; C11D 17/06; C11D 3/12; C11D 3/37; C11D 3/30; C11D 3/22; C11D 3/04; C11D 3/48

(52) U.S. Cl. CPC C11D 3/505; C11D 11/0017; C11D 17/06; C11D 3/128; C11D 3/3707; C11D 3/30; C11D 3/225; C11D 3/046; C11D 3/48; C11D 11/0082

(57) ABSTRACT

A laundry composition including a plurality of granules, where each of said granules has a longest dimension of no less than 3 mm and no more than 12 mm, and an aspect ratio of no more than 5, and each of said granules has a mass from 1 mg to 1 g; wherein said granules comprise 25% to 99.9% of a water soluble carrier by weight of the granules. The laundry composition also includes from 0.1% to 10% of a plurality of fine particles, by weight of the laundry composition, said fine particles having an average particle size of 0.05 μm to 50 μm.

### FIELD OF THE INVENTION

The present invention relates to particulate laundry composition, especially particulate laundry composition comprising softening and/or freshing wash additive.

### BACKGROUND OF THE INVENTION

The home laundering process provides consumers with the opportunity to treat fabrics with a multitude of materials which can impart desirable benefits to the fabric during the wash and/or rinse cycle. Benefits such as softening or freshing can be brought by functional compositions (such as perfume particles, bleach particles, softening particles) in a package that is separate from the package of detergent composition. Having the softening/freshing composition particles in a package separate from the package of laundry detergent product can be beneficial since it allows the consumer to select the amount of softening/freshing composition independent of the amount of detergent composition used. This can give the consumer the opportunity to customize the amount of softening/freshing composition used and thereby the amount of softening/freshing benefit they achieve, which is a highly valuable consumer benefit. With this said, relatively large and thick functional particles (e.g. perfume particles with a diameter of 3 mm or more and an aspect ratio of 5 or less) have been introduced in market. Such softening/freshing functional particles can be dosed by the consumer together with the laundry detergent product at the washing step, so called softening/freshing through the wash. This is contrary to the inconvenient experience caused by use of a liquid softening product which has to be dosed separate from the detergent product, into a different compartment of washing machine or dosed during the consequent step of rinsing or drying, so called softening through the rinse. However, there is a potential risk that the particulate functional particles in a package may lose its desirable flowability (e.g. some particles may stick together) under extreme conditions such as high temperature (e.g. 40° C. or above) and/or high humidity (e.g., 60% or above) during the transportation, storage, and/or manufacturing processes. This would bring about undesirable user experience because the product may become difficult to dispense due to its reduced flowability or when multiple particles stick together to form a large lump that blocks the container opening.

Therefore, there is a need to address the above concern, i.e. providing a particulate laundry composition having a desirable flowability.

### SUMMARY OF THE INVENTION

The composition described herein can provide for a laundry composition that has improved flowability that is more resistant to environmental changes (e.g., high temperature/humidity), and hence more convenient for the consumer to dose into the washing machine. The laundry composition can be provided in a particulate composition comprising softening and/or freshing wash additive. Particulate products, especially particulates that are not dusty, are preferred by many consumers. Particulate products can be easily dosed by consumers from a package directly into the washing machine or into a dosing compartment on the washing machine. Or the consumer can dose from the package into a dosing cup that optionally provides one or more dosing indicia and then dose the particulates into a dosing compartment on the washing machine or directly to the drum. For products in which a dosing cup is employed, particulate products tend to be less messy than liquid products. The composition described herein can provide a particulate composition having a desirable flowability, even in extreme conditions. Further, it is an advantage for the particulate laundry composition of the present invention to have less dusty characteristics, which is preferred by the consumer. It is an advantage for the particulate laundry composition can be easily dosed from package into a dosing cup or directly dosed into washing machine.

The laundry composition can comprise a plurality of granules having relatively larger size (e.g. longest dimension from 3 mm to 12 mm) and a plurality of fine particles having relatively smaller size (e.g. from 0.05 μm to 50 μm, or e.g. from 0.1 μm to 15 μm). The applicant discovers, surprisingly and unexpectedly, that the addition of fine particles having a relatively small range of average particle size into a particulate laundry composition with a mass of 1 mg to 1 g and a shape with longest dimension of from 3 mm to 12 mm, can significantly increase the flowability of such laundry composition, especially under extreme conditions such as high temperature (e.g. 40° C. or above) and/or high humidity (e.g., 60% or above) during transportation, storage, or manufacturing process.

Without being bound by any theories, inventors of the present invention believe that the fine particles added into the plurality of the granules, may cover either a portion of the outer surface, or the entire outer surface of the granules. The fine particles can form a continuous layer on the outer surface of the granules, or can be discontinuous and covering discrete regions of the outer surface of the granules. The fine particles may function to reduce the surface stickiness of the granules.

In one aspect, the present invention relates to a laundry composition, comprising:
i) a plurality of granules, where each of said granules has a longest dimension of no less than 3 mm and no more than 12 mm, and an aspect ratio of no more than 5, and where each of said granules has a mass from 1 mg to 1 g; wherein preferably said granules comprise 25% to 99.9% of a water-soluble carrier by weight of the granules, and
ii) from 0.1% to 10% of a plurality of fine particles, by weight of the laundry composition, said fine particles having an average particle size of 0.05 μm to 50 μm.

In another aspect, the present invention relates to a laundry composition comprising:
i) from 25% to 99.9% of a plurality of granules by weight of the laundry composition, where each of said granules has a hemispherical or compressed hemispherical shape, where each of said granules has a longest dimension of no less than 3 mm and no more than 12 mm, and an aspect ratio of no more than 5, wherein each of said granules has a mass from 1 mg to 1 g; and where said granules comprise 25% to 99.9%, by weight of the granules, of a polyethylene glycol having a weight average molecular weight from 3,000 to 13,000 Daltons;
ii) from 0.1% to 10% of a plurality of fine particles by weight of the laundry composition, said fine particles having an average particle size of from 0.1 μm to 15 μm, preferably from 1 μm to 10 μm, where said fine particles are selected from the group consisting of zeolite, fume silica, precipitated silica, calcium carbonate, titanium dioxide, magnesium carbonate, clays, kaolins, calcium stearate, magnesium stearate, starch, and combinations thereof.

In still another aspect, the present invention relates to a laundry composition comprising:
(i) from 10% to 90% of a plurality of first granules by weight of the laundry composition, wherein each of said first granules has a hemispherical or compressed hemispherical shape, wherein each of said first granules has a longest dimension of no less than 3 mm and no more than 12 mm, and an aspect ratio of no more than 5; wherein said first granules comprise:
   (a) from 25% to 99.9%, by weight of the first granules, of a polyethylene glycol having a weight average molecular weight from 3,000 to 13,000 Daltons; and
   (b) from 0.1% to 25%, by weight of the granules, of a perfume ingredient selected from free perfumes, pro-perfumes, encapsulated perfumes, perfume microcapsules, and combinations thereof;
(ii) from 10% to 90% of a plurality of second granules by weight of the laundry composition, wherein each of said second granules has a hemispherical or compressed hemispherical shape, wherein each of said second granules has a longest dimension of no less than 3 mm and no more than 12 mm, and an aspect ratio of no more than 5; wherein said second granules comprise:
   (c) from 25% to 99.9%, by weight of the second granules, of a polyethylene glycol having a weight average molecular weight from 3,000 to 13,000 Daltons,
   (d) from 0.5% to 40%, by weight of the second granules, of an ester quaternary ammonium compound; and
   (e) from 0.2% to 5%, by weight of the second granules, of a cationic polysaccharide; and
(iii) from 0.1% to 10% of a plurality of fine particles by weight of the laundry composition, said fine particles having an average particle size of from 0.1 μm to 15 μm, preferably from 1 μm to 10 μm, wherein said fine particles are selected from the group consisting of zeolite, fume silica, precipitated silica, calcium carbonate, titanium dioxide, magnesium carbonate, clays, kaolins, calcium stearate, magnesium stearate, starch, and combinations thereof.

In yet another aspect, the present invention relates to a method of making a laundry composition, comprising the step of: (a) providing a viscous material comprising from 40% to 99% by weight of the composition of polyethylene glycol, wherein said polyethylene glycol has a weight average molecular weight from 3,000 to 13,000 Daltons; (b) passing said viscous material through small openings and onto a moving conveyor surface upon which said viscous material is cooled to form a plurality of granules, and (c) mixing the plurality of granules with a plurality of fine particles having an average particle size of from 0.1 μm to 15 μm, to form said laundry composition.

In still yet another aspect, the present invention relates to a process for treating an article of clothing comprising the steps of: (i) providing an article of clothing in a washing machine; and (ii) contacting said article of clothing during a wash sub-cycle of said washing machine with the composition according to the present invention.

### DETAILED DESCRIPTION OF THE INVENTION

Features and benefits of the various embodiments of the present invention will become apparent from the following description, which includes examples of specific embodiments intended to give a broad representation of the invention. Various modifications will be apparent to those skilled in the art from this description and from practice of the invention. The scope of the present invention is not intended to be limited to the particular forms disclosed and the invention covers all modifications, equivalents, and alternatives falling within the spirit and scope of the invention as defined by the claims.

As used herein, terms such as “a” and “an” when used in a claim, are understood to mean one or more of what is claimed or described. The terms “comprise,” “comprises,” “comprising,” “contain,” “contains,” “containing,” “include,” “includes” and “including” are all meant to be non-limiting.

The term “particulate laundry detergent composition” refers to a solid powdery or granular laundry detergent composition, preferably a free-flowing powdery or granular laundry detergent composition, such as an all-purpose or heavy-duty washing agent for fabrics, as well as laundry auxiliaries such as bleach actives, rinse aids, additives, or pre-treat products.

The term “aspect ratio” refers to the ratio of the longest dimension of the granules over its shortest dimension. For example, when such granules have a hemispherical or compressed hemispherical shape, the aspect ratio is the ratio between the based diameter of the granules over its height.

The term “consisting essentially of” means that the composition contains less than about 1%, preferably less than about 0.5%, of ingredients other than those listed.

Further, the term “substantially free of” or “substantially free from” means that the indicated material is present in the amount of from 0 wt % to about 1 wt %, preferably from 0 wt % to about 0.5 wt %, more preferably from 0 wt % to about 0.2 wt %. The term “essentially free of” means that the indicated material is present in the amount of from 0 wt % to about 0.1 wt %, preferably from 0 wt % to about 0.01 wt %, more preferably it is not present at analytically detectable levels.

As used herein, all concentrations and ratios are on a weight basis unless otherwise specified. All temperatures herein are in degrees Celsius (° C.) unless otherwise indicated. All conditions herein are at 20° C. and under the atmospheric pressure, unless otherwise specifically stated. All polymer molecular weights are determined by weight average number molecular weight unless otherwise specifically noted.

The laundry composition of the present invention may comprise a plurality of granules and a plurality of fine particles. The laundry composition of the present invention may comprise a major proportion of granules, e.g. in an amount ranging from about 25% to about 99.9%, preferably from about 40% to about 99.5%, more preferably from about 45% to about 99.5%, by total weight of such particulate laundry composition.

The granules in the laundry composition are characterized by the following three (3) key features:
(1) a longest dimension of no less than about 3 mm, e g, from about 3 mm to about 12 mm, preferably from about 3 mm to about 10 mm, more preferably from about 4 mm to about 8 mm;
(2) an aspect ratio of no more than about 5, e.g., from about 1 to about 5, preferably from about 1.5 to about 4, more preferably from about 2 to about 4; and
(3) a mass of from about 1 mg to about 5 g, e.g. from about 1 mg to about 1 g, alternatively from about 5 mg to about 500 mg, alternatively from about 10 mg to about 250 mg, alternatively from about 15 mg to about 125 mg.

The composition containing granules with the above-described longest dimension, aspect ratio and mass can provide a significantly improved freshness/softening experience that delights consumers both visually and olfactorily when they are hand-washing the fabrics, and may also more likely to be used by the consumers as a scrubbing aid to treat a selected area of the fabrics during the wash. If the longest dimension is less than 3 mm or if the aspect ratio is greater than 5, the particulate composition may not be readily seen by the consumers during the hand-washing process, or they may not be perceived as strong enough for use as a scrubbing aid, thereby reducing or limiting their freshness/softening experience.

The composition may have a dissolution rate of no less than about 8 minutes, e.g., from about 8 minutes to about 60 minutes, preferably from about 10 minutes to about 45 minutes, more preferably from about 15 minutes to about 30 minutes, as measured in deionized water at 25° C. using the Dissolution Rate Test described hereinafter. If the dissolution rate of such particulate composition is less than 5 minutes, a majority of them may become completely dissolved before the consumers notice them, which also will lead to reduced or limited freshness experience.

The granules in the composition of the present invention may be formed into tablets, pills, spheres, and the like. They can have any shape selected from the group consisting of spherical, hemispherical, compressed hemispherical, cylindrical, disc, circular, lentil-shaped, oblong, cubical, rectangular, star-shaped, flower-shaped, and any combinations thereof. Lentil-shaped refers to the shape of a lentil bean. Compressed hemispherical refers to a shape corresponding to a hemisphere that is at least partially flattened such that the curvature of the curved surface is less, on average, than the curvature of a hemisphere having the same radius. A compressed hemispherical particle can have an aspect ratio (i.e., the ratio of its base diameter over its height that is orthogonal to the base) of from about 2.0 to about 5, alternatively from about 2.1 to about 4.5, alternatively from about 2.2 to about 4. Oblong-shaped particle refers to a particle having a maximum dimension and a secondary dimension orthogonal to the maximum dimension, wherein the ratio of maximum dimension to the secondary dimension is greater than about 1.2, preferably greater than about 1.5, more preferably greater than about 2.

Preferably, the granules in the laundry composition of the present invention have a hemispherical or compressed hemispherical shape. It has been discovered that such hemispherical or compressed hemispherical shape may help to significantly reduce segregation of the perfume particles, e.g., by nearly half in comparison with spherical perfume particles.

In a preferred but not necessary embodiment of the present invention, granules of the present invention have a density lower than water, so that they can float on water and are more noticeable by the consumers and more likely to be picked up by the consumers for use as a scrubbing aid during wash. For example, such granules may have a density ranging from about 0.5 g/cm³ to about 0.98 g/cm³, preferably from about 0.7 g/cm³ to about 0.95 g/cm³, more preferably from about 0.8 g/cm³ to about 0.9 g/cm³.

A plurality of granules in the laundry composition of the present invention can have different shapes, sizes, mass, and/or density.

### Water-Soluble Carrier

The granules can comprise a water-soluble carrier. The water-soluble carrier acts to carry the fabric care benefit agents to the wash liquor. Upon dissolution of the carrier, the fabric care benefit agents are dispersed into the wash liquor.

The water-soluble carrier can be a material that is soluble in a wash liquor within a short period of time, for instance less than about 10 minutes. The water-soluble carrier can be selected from the group consisting of water-soluble inorganic alkali metal salt, water-soluble alkaline earth metal salt, water-soluble organic alkali metal salt, water-soluble organic alkaline earth metal salt, water-soluble carbohydrate, water-soluble silicate, water-soluble urea, and any combination thereof.

Alkali metal salts can be, for example, selected from the group consisting of salts of lithium, salts of sodium, and salts of potassium, and any combination thereof. Useful alkali metal salts can be, for example, selected from the group consisting of alkali metal fluorides, alkali metal chlorides, alkali metal bromides, alkali metal iodides, alkali metal sulfates, alkali metal bisulfates, alkali metal phosphates, alkali metal monohydrogen phosphates, alkali metal dihydrogen phosphates, alkali metal carbonates, alkali metal monohydrogen carbonates, alkali metal acetates, alkali metal citrates, alkali metal lactates, alkali metal pyruvates, alkali metal silicates, alkali metal ascorbates, and combinations thereof.

Alkali metal salts can be selected from the group consisting of sodium fluoride, sodium chloride, sodium bromide, sodium iodide, sodium sulfate, sodium bisulfate, sodium phosphate, sodium monohydrogen phosphate, sodium dihydrogen phosphate, sodium carbonate, sodium hydrogen carbonate, sodium acetate, sodium citrate, sodium lactate, sodium tartrate, sodium silicate, sodium ascorbate, potassium fluoride, potassium chloride, potassium bromide, potassium iodide, potassium sulfate, potassium bisulfate, potassium phosphate, potassium monohydrogen phosphate, potassium dihydrogen phosphate, potassium carbonate, potassium monohydrogen carbonate, potassium acetate, potassium citrate, potassium lactate, potassium tartrate, potassium silicate, potassium, ascorbate, and combinations thereof.

Alkaline earth metal salts can be selected from the group consisting of salts of magnesium, salts of calcium, and the like, and combinations thereof. Alkaline earth metal salts can be selected from the group consisting of alkaline metal fluorides, alkaline metal chlorides, alkaline metal bromides, alkaline metal iodides, alkaline metal sulfates, alkaline metal bisulfates, alkaline metal phosphates, alkaline metal monohydrogen phosphates, alkaline metal dihydrogen phosphates, alkaline metal carbonates, alkaline metal monohydrogen carbonates, alkaline metal acetates, alkaline metal citrates, alkaline metal lactates, alkaline metal pyruvates, alkaline metal silicates, alkaline metal ascorbates, and combinations thereof. Alkaline earth metal salts can be selected from the group consisting of magnesium fluoride, magnesium chloride, magnesium bromide, magnesium iodide, magnesium sulfate, magnesium phosphate, magnesium monohydrogen phosphate, magnesium dihydrogen phosphate, magnesium carbonate, magnesium monohydrogen carbonate, magnesium acetate, magnesium citrate, magnesium lactate, magnesium tartrate, magnesium silicate, magnesium ascorbate, calcium fluoride, calcium chloride, calcium bromide, calcium iodide, calcium sulfate, calcium phosphate, calcium monohydrogen phosphate, calcium dihydrogen phosphate, calcium carbonate, calcium monohydrogen carbonate, calcium acetate, calcium citrate, calcium lactate, calcium tartrate, calcium silicate, calcium ascorbate, and combinations thereof.

Inorganic salts, such as inorganic alkali metal salts and inorganic alkaline earth metal salts, do not contain carbon. Organic salts, such as organic alkali metal salts and organic alkaline earth metal salts, contain carbon. The organic salt can be an alkali metal salt or an alkaline earth metal salt of sorbic acid (i.e., ascorbate). Sorbates can be selected from the group consisting of sodium sorbate, potassium sorbate, magnesium sorbate, calcium sorbate, and combinations thereof.

The water-soluble carrier can be or comprise a material selected from the group consisting of a water-soluble inorganic alkali metal salt, a water-soluble organic alkali metal salt, a water-soluble inorganic alkaline earth metal salt, a water-soluble organic alkaline earth metal salt, a water-soluble carbohydrate, a water-soluble silicate, a water-soluble urea, and combinations thereof. The water-soluble carrier can be selected from the group consisting of sodium chloride, potassium chloride, calcium chloride, magnesium chloride, sodium sulfate, potassium sulfate, magnesium sulfate, sodium carbonate, potassium carbonate, sodium hydrogen carbonate, potassium hydrogen carbonate, sodium acetate, potassium acetate, sodium citrate, potassium citrate, sodium tartrate, potassium tartrate, potassium sodium tartrate, calcium lactate, water glass, sodium silicate, potassium silicate, dextrose, fructose, galactose, isoglucose, glucose, sucrose, raffinose, isomalt, xylitol, candy sugar, coarse sugar, and combinations thereof. In one embodiment, the water-soluble carrier can be sodium chloride. In one embodiment, the water-soluble carrier can be table salt.

The water-soluble carrier can be or comprise a material selected from the group consisting of sodium bicarbonate, sodium sulfate, sodium carbonate, sodium formate, calcium formate, sodium chloride, sucrose, maltodextrin, corn syrup solids, corn starch, wheat starch, rice starch, potato starch, tapioca starch, clay, silicate, citric acid carboxymethyl cellulose, fatty acid, fatty alcohol, glyceryl diester of hydrogenated tallow, glycerol, and combinations thereof.

The water-soluble carrier can be selected from the group consisting of water-soluble organic alkali metal salt, water-soluble inorganic alkaline earth metal salt, water-soluble organic alkaline earth metal salt, water-soluble carbohydrate, water-soluble silicate, water-soluble urea, starch, clay, water insoluble silicate, citric acid carboxymethyl cellulose, fatty acid, fatty alcohol, glyceryl diester of hydrogenated tallow, glycerol, polyethylene glycol, and combinations thereof.

The water-soluble carrier can be selected from the group consisting of disaccharides, polysaccharides, silicates, zeolites, carbonates, sulfates, citrates, and combinations thereof.

The water-soluble carrier can be a water-soluble polymer. Water-soluble polymers can be selected from the group consisting of polyvinyl alcohols (PVA), modified PVAs; polyvinyl pyrrolidone; PVA copolymers such as PVA/polyvinyl pyrrolidone and PVA/polyvinyl amine; partially hydrolyzed polyvinyl acetate; polyalkylene oxides such as polyethylene oxide; polyethylene glycols; acrylamide; acrylic acid; cellulose, alkyl cellulosics such as methyl cellulose, ethyl cellulose and propyl cellulose; cellulose ethers; cellulose esters; cellulose amides; polyvinyl acetates; polycarboxylic acids and salts; polyaminoacids or peptides; polyamides; polyacrylamide; copolymers of maleic/acrylic acids; polysaccharides including starch, modified starch; gelatin; alginates; xyloglucans, other hemicellulosic polysaccharides including xylan, glucuronoxylan, arabinoxylan, mannan, glucomannan and galactoglucomannan; and natural gums such as pectin, xanthan, and carrageenan, locus bean, arabic, tragacanth; and combinations thereof. In one embodiment the polymer comprises polyacrylates, especially sulfonated polyacrylates and water-soluble acrylate copolymers; and alkylhydroxy cellulosics such as methylcellulose, carboxymethylcellulose sodium, modified carboxy-methylcellulose, dextrin, ethylcellulose, propylcellulose, hydroxyethyl cellulose, hydroxypropyl methylcellulose, maltodextrin, polymethacrylates. In yet another embodiment the water-soluble polymer can be selected from the group consisting of PVA; PVA copolymers; hydroxypropyl methyl cellulose (HPMC); and mixtures thereof.

The water-soluble carrier can be selected from the group consisting of polyvinyl alcohol, modified polyvinyl alcohol, polyvinyl pyrrolidone, polyvinyl alcohol/polyvinyl pyrrolidone, polyvinyl alcohol/polyvinyl amine, partially hydrolyzed polyvinyl acetate, polyalkylene oxide, polyethylene glycol, acrylamide, acrylic acid, cellulose, alkyl cellulosics, methyl cellulose, ethyl cellulose, propyl cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides, starch, modified starch, gelatin, alginates, xyloglucans, hemicellulosic polysaccharides, xylan, glucuronoxylan, arabinoxylan, mannan, glucomannan, galactoglucomannan, natural gums, pectin, xanthan, carrageenan, locus bean, arabic, tragacanth, polyacrylates, sulfonated polyacrylates, water-soluble acrylate copolymers, alkylhydroxy cellulosics, methylcellulose, carboxymethylcellulose sodium, modified carboxy-methylcellulose, dextrin, ethylcellulose, propylcellulose, hydroxyethyl cellulose, hydroxypropyl methylcellulose, maltodextrin, polymethacrylates, polyvinyl alcohol copolymers, hydroxypropyl methyl cellulose, and mixtures thereof.

The water-soluble carrier can be an organic material. Organic carriers may provide a benefit of being readily soluble in water.

The water-soluble carrier can be selected from the group consisting of polyethylene glycol, sodium acetate, sodium bicarbonate, sodium chloride, sodium silicate, polypropylene glycol polyoxyalkylene, polyethylene glycol fatty acid ester, polyethylene glycol ether, sodium sulfate, starch, and mixtures thereof.

The water-soluble carrier can be polyethylene glycol (PEG). PEG can be a convenient material to employ to make particles because it can be sufficiently water-soluble to dissolve during a wash cycle when the particles have the range of mass disclosed herein. Further, PEG can be easily processed as melt. The onset of melt temperature of PEG can vary as a function of molecular weight of the PEG. The particles can comprise about 25% to about 99.9%, by weight PEG having a weight average molecular weight from about 2,000 to about 20,000. PEG has a relatively low cost, may be formed into many different shapes and sizes, minimizes unencapsulated perfume diffusion, and dissolves well in water. PEG comes in various weight average molecular weights. A suitable weight average molecular weight range of PEG includes from about 2,000 to about 13,000, alternatively from about 4,000 to about 13,000, alternatively from about 4,000 to about 12,000, alternatively from about 4,000 to about 11,000, alternatively from about 5,000 to about 11,000, alternatively from about 6,000 to about 10,000, alternatively from about 7,000 to about 9,000, alternatively combinations thereof. PEG is available from BASF, for example PLURIOL E 8000 (which has a weight average molecular weight of 9000 even though 8000 is in the product name), or other PLURIOL product.

The granules can comprise about 25% to about 99.9% by weight of the granules of PEG. Optionally, the granules can comprise from about 30% to about 99.5%, optionally from about 35% to about 99%, optionally from about 50% to about 94%, optionally combinations thereof and any whole percentages or ranges of whole percentages within any of the aforementioned ranges, of PEG by weight of the respective granules.

The carrier can comprise a material selected from the group consisting of: a polyalkylene polymer of formula H—(C₂H₄O)ₓ—(CH(CH₃)CH₂O)_{y}—(C₂H₄O)_{z}—OH wherein x is from about 50 to about 300, y is from about 20 to about 100, and z is from about 10 to about 200; a polyethylene glycol fatty acid ester of formula (C₂H₄O)_{q}—C(O)O—(CH₂)ᵣ—CH₃ wherein q is from about 20 to about 200 and r is from about 10 to about 30; a polyethylene glycol fatty alcohol ether of formula HO—(C₂H₄O)ₛ—(CH₂)ₜ)—CH₃ wherein s is from about 30 to about 250 and t is from about 10 to about 30; and mixtures thereof. The polyalkylene polymer of formula H—(C₂H₄O)ₓ—(CH(CH₃)CH₂O)_{y}—(C₂H₄O)_{z}—OH wherein x is from about 50 to about 300, y is from about 20 to about 100, and z is from about 10 to about 200, can be a block copolymer or random copolymer.

The carrier can comprise: polyethylene glycol; a polyalkylene polymer of formula H—(C₂H₄O)ₓ—(CH(CH₃)CH₂O)_{y}—(C₂H₄O)_{z}—OH wherein x is from about 50 to about 300; y is from about 20 to about 100, and z is from about 10 to about 200; a polyethylene glycol fatty acid ester of formula (C₂H₄O)_{q}—C(O)O—(CH₂)ᵣ—CH₃ wherein q is from about 20 to about 200 and r is from about 10 to about 30; and a polyethylene glycol fatty alcohol ether of formula HO—(C₂H₄O)ₛ—(CH₂)ₜ)—CH₃ wherein s is from about 30 to about 250 and t is from about 10 to about 30.

The carrier can comprise from about 20% to about 80% by weight of the granules of polyalkylene polymer of formula H—(C₂H₄O)ₓ—(CH(CH₃)CH₂O)_{y}—(C₂H₄O)_{z}—OH wherein x is from about 50 to about 300; y is from about 20 to about 100, and z is from about 10 to about 200.

The carrier can comprise from about 1% to about 20% by weight of the granules polyethylene glycol fatty acid ester of formula (C₂H₄O)_{q}—C(O)O—(CH₂)ᵣ—CH₃ wherein q is from about 20 to about 200 and r is from about 10 to about 30.

The carrier can comprise from about 1% to about 10% by weight of the granules of polyethylene glycol fatty alcohol ether of formula HO—(C₂H₄O)ₛ—(CH₂)ₜ)—CH₃ wherein s is from about 30 to about 250 and t is from about 10 to about 30.

### Perfume Ingredients

The granules in the laundry composition of the present invention may comprise from about 0.1 wt % to about 25 wt %, optionally from about 0.2 wt % to 20 wt %, preferably from about 0.5 wt % to about 15 wt %, more preferably from about 1 wt % to about 10 wt % of one or more perfume ingredients, such as free perfumes, pro-perfumes, encapsulated perfumes, perfume microcapsules, and the like. The granules may comprise free perfumes, encapsulated perfumes, and/or perfume microcapsules. In one embodiment, the granules comprise free perfumes and are substantially or essentially free of encapsulated perfumes or perfume microcapsules. In yet another embodiment, the granules comprise encapsulated perfumes (i.e., perfumes carried by a carrier material such as starch, cyclodextrin, silica, zeolites or clay) or perfume microcapsules, but are substantially or essentially free of free perfumes. In yet another embodiment, the granules comprises both free perfumes and encapsulated perfumes or perfume microcapsules, e.g., at a weight ratio ranging from about 1:5 to about 5:1, alternatively from about 1:4 to about 4:1, further alternatively from about 1:3 to about 3:1.

Preferably, such granules contain perfume microcapsules (PMCs), especially friable PMCs. For purpose of the present invention, the term “perfume microcapsules” or PMCs cover both perfume microcapsules and perfume nanoparticles. In one embodiment, the PMCs comprise melamine/formaldehyde shells, which are commercially available from Appleton, Quest International, International Flavor & Fragrances, or other suitable sources. In a preferred embodiment, the shells of the PMCs are coated with polymer to enhance the ability of the PMCs to adhere to fabric. The granules in the laundry composition of the present invention may comprise from about 0.1 wt % to about 20 wt %, preferably from about 1 wt % to about 18 wt %, more preferably from about 5 wt % to about 15 wt % of perfume microcapsules.

### Quaternary Ammonium Compound

The granules can comprise a quaternary ammonium compound so that the granules can provide a softening benefit to laundered fabrics through the wash, and in particular during the wash sub-cycle of a washer having wash and rinse sub-cycles. The quaternary ammonium compound (quat) can be an ester quaternary ammonium compound. Suitable quaternary ammonium compounds include but are not limited to, materials selected from the group consisting of ester quats, amide quats, imidazoline quats, alkyl quats, amidoester quats and combinations thereof. Suitable ester quats include but are not limited to, materials selected from the group consisting of monoester quats, diester quats, triester quats and combinations thereof.

Without being bound by any theory, it is thought that the Dispersion Time of the granules that include a quaternary ammonium compound tends to decrease with increasing Iodine Value, recognizing that there is some variability with respect to this relationship.

The granules can comprise about 0.2% to about 45% by weight of a quaternary ammonium compound. The quaternary ammonium compound can optionally have an Iodine Value from about 18 to about 60, optionally about 18 to about 56, optionally about 20 to about 60, optionally about 20 to about 56, optionally about 20 to about 42, and any whole numbers within the aforesaid ranges. Optionally the granules can comprise about 0.5% to about 40% by weight of a quaternary ammonium compound, further optionally having any of the aforesaid ranges of Iodine Value. Optionally the granules can comprise about 5% to about 40% by weight a quaternary ammonium compound, further optionally having the aforesaid ranges of Iodine Value.

The quaternary ammonium compound used in the present invention can be those described in e.g. U.S. Ser. No. 10/377,966B2, U.S. Ser. No. 10/392,582B2, or U.S. Ser. No. 10/487,293B2.

### Cationic Polymer

The granules in the laundry composition of the present invention can comprise a cationic polymer. Cationic polymers can provide the benefit of a deposition aid that helps to deposit onto the fabric quaternary ammonium compound and possibly some other benefit agents that are contained in the granules.

The granules can comprise about 0.1% to about 10% by weight of cationic polymer. Optionally, the granules can comprise about 0.2% to about 5% by weight cationic polymer, or even about 0.5% to about 5% by weight, or even about 1% to about 4% by weight cationic polymer, or even about 3% by weight cationic polymer. Without being bound by theory, it is thought that the cleaning performance of laundry detergent in the wash decreases with increasing levels of cationic polymer in the granules and acceptable cleaning performance of the detergent can be maintained within the aforesaid ranges.

The cationic polymer can have a cationic charge density more than about 0.05 meq/g (meq meaning milliequivalents), to 23 meq/g, preferably from about 0.1 meq/g to about 4 meq/g. even more preferably from about 0.1 meq/g to about 2 meq/g and most preferably from 0.1 meq/g to about 1 meq/g.

The above referenced cationic charge densities can be at the pH of intended use, which can be a pH from about 3 to about 9, optionally about 4 to about 9.

Cationic charge density of a polymer refers to the ratio of the number of positive charges on the polymer to the molecular weight of the polymer. Charge density is calculated by dividing the number of net charges per repeating unit by the molecular weight of the repeating unit. The positive charges may be located on the backbone of the polymers and/or the side chains of polymers. The average molecular weight of such suitable cationic polymers can generally be between about 10,000 and about 10 million, or even between about 50,000 and about 5 million, or even between about 100,000 and about 3 million.

The suitable cationic polymers used in the present invention can be those described in e.g. U.S. Ser. No. 10/377,966B2, U.S. Ser. No. 10/392,582B2, or U.S. Ser. No. 10/487,293B2. Non-limiting examples of cationic polymers are cationic or amphoteric, polysaccharides, proteins and synthetic polymers. Cationic polysaccharides include cationic cellulose derivatives, cationic guar gum derivatives, chitosan and its derivatives and cationic starches. Cationic polysaccharides have a molecular weight from about 1,000 to about 2 million, preferably from about 100,000 to about 800,000. Suitable cationic polysaccharides include cationic cellulose ethers, particularly cationic hydroxyethylcellulose and cationic hydroxypropylcellulose.

In another aspect, the cationic polymer may be selected from the group consisting of cationic polysaccharides. In one aspect, the cationic polymer may be selected from the group consisting of cationic cellulose ethers, cationic galactomannan, cationic guar gum, cationic starch, and combinations thereof.

The weight-average molecular weight of the cationic polymer may be from about 500 to about 5,000,000, or from about 1,000 to about 2,000,000, or from about 5000 to about 1,000,000 Daltons, as determined by size exclusion chromatography relative to polyethyleneoxide standards with RI detection. In one aspect, the weight-average molecular weight of the cationic polymer may be from about 100,000 to about 800,000 Daltons.

The cationic polymer can be provided in a powder form. The cationic polymer can be provided in an anhydrous state.

### Anti-Microbial Agents

The granules in the laundry composition of the present invention may optionally comprise a diphenyl ether anti-microbial agent. Preferably, the granules may comprise from about 0.01% to about 3%, preferably from about 0.02% to about 2%, more preferably from about 0.05% to about 1%, most preferably from about 0.1% to about 0.5% of said diphenyl ether anti-microbial agent by weight of the granules.

The diphenyl ether anti-microbial agent can be either halogenated or non-halogenated, but preferably is halogenated. In a preferred embodiment, the diphenyl ether anti-microbial agent is a hydroxyl diphenyl ether of formula (I):

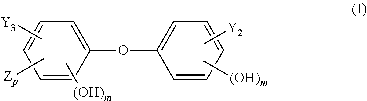

wherein:
each Y is independently selected from chlorine, bromine, or fluorine, preferably is chlorine or bromine, more preferably is chlorine,
each Z is independently selected from SO₂H, NO₂, or C₁-C₄ alkyl,
r is 0, 1, 2, or 3, preferably is 1 or 2,
o is 0, 1, 2, or 3, preferably is 0, 1 or 2,
p is 0, 1, or 2, preferably is 0,
m is 1 or 2, preferably is 1, and
n is 0 or 1, preferably is 0.

In the above definition for formula (I), 0 means nil. For example, when p is 0, then there is no Z in formula (I). Each Y and each Z could be the same or different. In one embodiment, o is 1, r is 2, and Y is chlorine or bromine. This embodiment could be: one chlorine atom bonds to a benzene ring while the bromine atom and the other chlorine atom bond to the other benzene ring; or the bromine atom bonds to a benzene ring while the two chlorine atoms bond to the other benzene ring.

More preferably, the diphenyl ether anti-microbial agent is selected from the group consisting of 4-4′-dichloro-2-hydroxy diphenyl ether, 2,4,4′-trichloro-2′-hydroxy diphenyl ether, and a combination thereof. Most preferably, said diphenyl ether anti-microbial agent is more preferably 4-4′-dichloro-2-hydroxy diphenyl ether.

In addition to the diphenyl ether anti-microbial agents disclosed hereinabove, other anti-microbial agents may also be present, provided that these are not present at a level which causes instability in the formulation. Among such useful further antimicrobial agents are chelating agents, which are particularly useful in reducing the resistance of Gram negative microbes in hard water. Acid biocides may also be present.

### Other Actives

The granules in the laundry composition of the present invention can further comprise other active ingredients, e.g. surfactants, enzymes, colorants, fatty acid, antioxidant, etc. The granules in the laundry composition of the present invention can comprise fatty acid.

The term “fatty acid” is used herein in the broadest sense to include unprotonated or protonated forms of a fatty acid. One skilled in the art will readily appreciate that the pH of an aqueous composition will dictate, in part, whether a fatty acid is protonated or unprotonated. The fatty acid may be in its unprotonated, or salt form, together with a counter ion, such as, but not limited to, calcium, magnesium, sodium, potassium, and the like. The term “free fatty acid” means a fatty acid that is not bound to another chemical moiety (covalently or otherwise).

The fatty acid may include those containing from 12 to 25, from 13 to 22, or even from 16 to 20, total carbon atoms, with the fatty moiety containing from 10 to 22, from 12 to 18, or even from 14 (mid-cut) to 18 carbon atoms.

The fatty acids may be derived from (1) an animal fat, and/or a partially hydrogenated animal fat, such as beef tallow, lard, etc.; (2) a vegetable oil, and/or a partially hydrogenated vegetable oil such as canola oil, safflower oil, peanut oil, sunflower oil, sesame seed oil, rapeseed oil, cottonseed oil, corn oil, soybean oil, tall oil, rice bran oil, palm oil, palm kernel oil, coconut oil, other tropical palm oils, linseed oil, tung oil, etc.; (3) processed and/or bodied oils, such as linseed oil or tung oil via thermal, pressure, alkali-isomerization and catalytic treatments; (4) combinations thereof, to yield saturated (e.g. stearic acid), unsaturated (e.g. oleic acid), polyunsaturated (linoleic acid), branched (e.g. isostearic acid) or cyclic (e.g. saturated or unsaturated α-disubstituted cyclopentyl or cyclohexyl derivatives of polyunsaturated acids) fatty acids.

Mixtures of fatty acids from different fat sources can be used.

The cis/trans ratio for the unsaturated fatty acids may be important, with the cis/trans ratio (of the C18:1 material) being from at least 1:1, at least 3:1, from 4:1 or even from 9:1 or higher.

Branched fatty acids such as isostearic acid are also suitable since they may be more stable with respect to oxidation and the resulting degradation of color and odor quality.

The fatty acid may have an iodine value from 0 to 140, from 50 to 120 or even from 85 to 105.

The granules may comprise from about 1% to about 40% by weight fatty acid. The fatty acid may be selected from the group consisting of, a saturated fatty acids, unsaturated fatty acid, and mixtures thereof. The fatty acid may be a blend of saturated fatty acids, a blend of unsaturated fatty acids, and mixtures thereof. The fatty acid may be substituted or unsubstituted. The fatty acid may be provided with the quaternary ammonium compound. The fatty acid may have an Iodine Value of zero.

The fatty acid may be selected from the group consisting of stearic acid, palmitic acid, coconut oil, palm kernel oil, stearic acid palmitic acid blend, oleic acid, vegetable oil, partially hydrogenated vegetable oil, and mixtures thereof.

The fatty acid may be Stearic acid CAS No. 57-11-4. The fatty acid may be palmitic acid CAS No. 57-10-3. The fatty acid may be a blend of stearic acid and coconut oil.

The fatty acid may be C12 to C22 fatty acid. C12 to C22 fatty acid may have tallow or vegetable origin, may be saturated or unsaturated, may be substituted or unsubstituted.

Without being bound by theory, fatty acid may help as a processing aid for uniformly mixing the formulation components of the granules.

The granules of the present invention may optionally comprise one or more colorants, e.g., dyes, pigments, and combinations thereof, in an amount ranging from about 0.0001 wt % to about 1 wt %, preferably from about 0.001 wt % to about 0.5 wt %, more preferably from about 0.005 wt % to about 0.1 wt %. More preferably, the colorants impart to the granules a color selected from the group consisting of blue, green, yellow, orange, pink, red, purple, grey, and the like, so that such granules are visually contrasting with detergent particles of a white or light-colored appearance in the particulate laundry detergent composition of the present invention. An example of a dye includes LIQUITINT BLUE BL or LIQUITINT VIOLET BL from Millikin Chemical.

The granules may optionally comprise an antioxidant. The antioxidant may help to promote stability of the color and or odor of the granules over time between production and use. The granules may comprise from about 0.01% to about 1% by weight antioxidant, optionally from about 0.001% to about 2% by weight antioxidant, optionally from about 0.01% to about 0.1% by weight antioxidant. The antioxidant may be butylated hydroxytoluene.

In some preferred embodiments, the granules in the laundry composition of the present invention are substantially free of or essentially free of surfactants, because the presence of such surfactants may speed up dissolution of the granules in water, which is undesirable in the context of the present invention. More preferably, the granules of the present invention are substantially free of or essentially free of any detersive actives.

### Granules

The granules may have individual mass from about 1 mg to about 1 g. The smaller the granules the faster they tend to dissolve in water. The plurality of granules may have an individual or mean particle mass of from about 1 mg to about 1000 mg, alternatively from about 5 mg to about 500 mg, alternatively from about 5 mg to about 200 mg, alternatively from about 10 mg to about 100 mg, alternatively from about 20 mg to about 50 mg, alternatively from about 35 mg to about 45 mg, alternatively about 38 mg. The plurality of granules may have standard deviation of mass of less than about 30 mg, alternatively less than about 15 mg, alternatively less than about 5 mg, alternatively about 3 mg. The mean particle of mass within the aforesaid ranges may provide for a Dispersion Time in water that permits the granules to dissolve during a typical wash cycle. Without being bound by theory, it is thought that granules have such a standard deviation of mass may have a more uniform Dispersion Time in water as compared to granules having a broader standard deviation of mass. The smaller the standard deviation of mass of the granules the more uniform the Dispersion Time. The mass of the individual granules forming the plurality granules may be set to provide the desired Dispersion Time, which might be some fraction of the length of the typical washing cycle in a washing machine. Granules formed from polyethylene glycol having a weight average molecular weight of about 9000 may have mean particle mass of about 38 mg and standard deviation of mass of about 3 mg.

The plurality of granules may be substantially free from granules having a mass less than 10 mg. This may be practical for limiting the ability of the granules to become airborne.

An individual particle may have a volume from about 0.003 cm³ to about 5 cm³, optionally from about 0.003 cm³ to about 1 cm³, optionally from about 0.003 cm³ to about 0.5 cm³, optionally from about 0.003 cm³ to about 0.2 cm³, optionally from about 0.003 cm³ to about 0.15 cm³. Smaller granules are thought to provide for better packing of the granules in a container and faster dissolution in the wash.

The composition may comprise granules that are retained on a number 10 sieve as specified by ASTM International, ASTM E11-13. The composition may comprise granules wherein more than about 50% by weight, optionally more than about 70% by weight, optionally more than about 90% by weight, of the granules are retained on a number 10 sieve as specified by ASTM International, ASTM E11-13. It can be desirable to provide granules sized as such because granules retained on a number 10 sieve may be easier to handle than smaller granules.

The composition may comprise granules that are retained on a number 6 sieve as specified by ASTM International, ASTM E11-13. The composition may comprise granules wherein more than about 50% by weight, optionally more than about 70% by weight, optionally more than about 90% by weight, of the granules are retained on a number 6 sieve as specified by ASTM International, ASTM E11-13. It can be desirable to provide granules sized as such because granules retained on a number 6 sieve may be easier to handle than smaller granules.

The composition may comprise granules that pass a sieve having a nominal sieve opening size of 22.6 mm. The composition may comprise granules that pass a sieve having a nominal sieve opening size of 22.6 mm and are retained on a sieve having a nominal sieve opening size of 0.841 mm Granules having a size such that they are retained on a sieve having a nominal opening size of 22.6 mm may tend to have a Dispersion Time that is too great for a common wash cycle. Granules having a size such that they pass a sieve having a nominal sieve opening size of 0.841 mm may be too small to conveniently handle. Granules having a size within the aforesaid bounds may represent an appropriate balance between Dispersion Time and ease of particle handling.

Granules having the size disclosed herein can be substantial enough so that they do not readily become airborne when poured from a container, dosing cup, or other apparatus, into a wash basin or washing machine. Further, such granules as disclosed herein might be able to be easily and accurately poured from a container into a dosing cup. So, such granules may make it easy for the consumer to control the amount of quaternary ammonium compound he or she delivers to the wash.

### Fine Particles

The laundry composition of the present invention comprises a plurality of fine particles. Said fine particles have an average particle size of about 0.1 μm to about 15 μm. Preferably, the fine particles have an average particle size of from about 1 μm to about 10 μm, for example from about 2 μm to about 10 μm, or about 2 μm, or about 3 μm, or about 5 μm. The fine particles are added to the laundry composition to make the granules less sticky. The plurality of fine particles at least partially coat the plurality of granules described hereinwith. While the desired state is for granules which are completely coated by the fine particle, it is, of course, anticipated that complete coverage will not be possible in all cases in a continuous, high speed manufacturing process. When the average particle size is larger than 15 μm, the fine particle may not able to form a uniform and good coating on the granules. While it is rather difficult to quantify the extent of the coating coverage, it is observed that increasing the amount of the fine particles in some extent, results in improved benefits. Accordingly, in preferred embodiments of the present invention, the fine particle is present in an amount of about 0.1% or more, by weight of the composition. Preferably, the file particle is present in the amount of about 0.2%, bye weight of the composition. The applicant, at the same time, discovers that, if the amount of the fine particles increases too much, undesirable residue will be observed. With the balance of improving flowability and minimum of undesired residue, the fine particles may be present in the amount of no more than about 5% by weight of the composition. Preferably, the fine particle is in the amount of from 0.1% to 5%, or optionally from about 0.2% to about 4%, or optionally from about 0.3% to 3%, more preferably from 0.3% to 2%.

The fine particles may comprise a material selected from the group consisting of zeolite, fume silica, precipitated silica, calcium carbonate, titanium dioxide, magnesium carbonate, clays, kaolins, calcium stearate, magnesium stearate, starch and the combinations thereof. Optionally, other organic or inorganic materials which can provide good flowability and not impart the effect of the present invention can be used, as long as the materials are particles having average particle size from 0.1 μm to 15 μm.

### Particulate Laundry Composition

The composition of the present invention may collectively comprise a dose for dosing to a laundry washing machine or laundry wash basin. A single dose may comprise from about 1 g to about 50 g of the composition. A single dose may comprise from about 5 g to about 50 g, alternatively from about 10 g to about 45 g, alternatively from about 20 g to about 40 g, alternatively combinations thereof and any whole numbers of grams or ranges of whole numbers of grams within any of the aforementioned ranges. The individual granules forming the plurality of granules that can make up the dose can have a mass from about 1 mg to about 5000 mg, alternatively from about 1 mg to about 1000 mg, alternatively from about 5 mg to about 200 mg, alternatively from about 10 mg to about 200 mg, alternatively from about 15 mg to about 50 mg, alternatively from about 20 mg to about 50 mg, alternatively from about 35 mg to about 45 mg, alternatively about 38 mg, alternatively combinations thereof and any whole numbers or ranges of whole numbers of mg within any of the aforementioned ranges. The plurality of granules can be made up of granules having different size, shape, and/or mass. The granules in a dose can each have a maximum dimension less than about 15 mm Each of the granules in a dose can have a maximum dimension less than about 1 cm.

In a preferred embodiment, the laundry composition may comprise from 25% to 99.9% of a plurality of granules, and from 0.1% to 10% of a plurality of fine particles, by weight of the laundry composition. Each of said granules has a hemispherical or compressed hemispherical shape, and each of said granules has a longest dimension of no less than 3 mm and no more than 12 mm, and an aspect ratio of no more than 5. Each of said granules has a mass from 1 mg to 1 g. Said granules comprise 25% to 99.9%, by weight of the granules, of a polyethylene glycol having a weight average molecular weight from 3,000 to 13,000 Daltons. Said fine particles have an average particle size of from 0.1 μm to 15 μm, preferably from 1 μm to 10 μm, and the fine particles are selected from the group consisting of zeolite, fume silica, precipitated silica, calcium carbonate, titanium dioxide, magnesium carbonate, clays, kaolins, calcium stearate, magnesium stearate, starch, and combinations thereof.

In another preferred embodiment, the laundry composition comprises a plurality of first granules containing PEG and perfume, a plurality of second granules containing PEG, an ester quaternary ammonium compound, and an a cationic polysaccharide; as well as a plurality of fine particles having an average particle size of from 0.1 μm to 15 μm. The first granules may be present in an amount of 10% to 90% in the composition. The second granules may be present in an amount of 10% to 90% in the composition. The fine particles may be present in an amount of 0.1% to 10% of the composition. Specifically, each of said first granules and second granules may have a hemispherical or compressed hemispherical shape, or have a shape with at least one substantially flat or flat surface.

Further each of said first granules and second granules may be characterized by at least two, preferably all of the following three (3) key features:

(1) a longest dimension of no less than about 3 mm, e.g., from about 3 mm to 12 mm, preferably from about 3 mm to about 10 mm, more preferably from about 4 mm to about 8 mm;

(2) an aspect ratio of no more than about 5, e.g., from about 1 to about 5, preferably from about 1.5 to about 4, more preferably from about 2 to about 4; and

(3) a mass of from about 1 mg to 5 g, e.g. from about 1 mg to about 1 g, alternatively from about 5 mg to about 500 mg, alternatively from about 10 mg to about 250 mg, alternatively from about 15 mg to about 125 mg.

The first granules may comprise, by weight of the first granules, from 25% to 99.9% of a polyethylene glycol having a weight average molecular weight from 3,000 to 13,000 Daltons; and from 0.1% to 25% of a perfume ingredient selected from free perfumes, pro-perfumes, encapsulated perfumes, perfume microcapsules, and combinations thereof.

The second granules may comprise, i) from 25% to 99.9%, by weight of the second granules, of a polyethylene glycol having a weight average molecular weight from 3,000 to 13,000 Daltons; ii) from 0.5% to 40%, by weight of the second granules, of an ester quaternary ammonium compound; and iii) from 0.2% to 5%, by weight of the second granules, of a cationic polysaccharide.

The fine particles in the composition of the present invention may have an average particle size of from 0.1 μm to 15 μm, preferably from 1 μm to 10 μm, wherein said fine particles are selected from the group consisting of zeolite, fume silica, precipitated silica, calcium carbonate, titanium dioxide, magnesium carbonate, clays, kaolins, calcium stearate, magnesium stearate, starch, and combinations thereof.

### Production of the Laundry Composition

The plurality of granules in the laundry composition can be produced by the method described hereinafter. For a carrier that can be processed conveniently as a melt, the rotoforming process can be used. A mixture of molten carrier and the other materials constituting the granules is prepared, for instance in a batch or continuous mixing process. The molten mixture can be pumped to a rotoformer, for instance a Sandvik ROTOFORM 3000 having a 750 mm wide 10 m long belt. The rotoforming apparatus can have a rotating cylinder. The cylinder can have 2 mm diameter apertures set at a 10 mm pitch in the cross machine direction and 9.35 mm pitch in the machine direction. The cylinder can be set at approximately 3 mm above the belt. The belt speed and rotational speed of the cylinder can be set at about 10 m/min. The molten mixture can be passed through the apertures in the rotating cylinder and deposited on a moving conveyor that is provided beneath the rotating cylinder.

The molten mixture can be cooled on the moving conveyor to form a plurality of solid granules. The cooling can be provided by ambient cooling. Optionally the cooling can be provided by spraying the under-side of the conveyor with ambient temperature water or chilled water.

Once the granules are sufficiently coherent, the granules can be transferred from the conveyor to processing equipment downstream of the conveyor for further processing and or packaging.

Optionally, the granules can be provided with inclusions of a gas. Such occlusions of gas, for example air, can help the granules dissolve more quickly in the wash. Occlusions of gas can be provided, by way of nonlimiting example, by injecting gas into the molten precursor material and milling the mixture.

The granules in the laundry composition can also be made using other approaches. For instance, granulation or press agglomeration can be appropriate. In granulation, the precursor material containing the constituent materials of the granules is compacted and homogenized by rotating mixing tools and granulated to form granules. For precursor materials that are substantially free of water, a wide variety of sizes of granules can be made.

In press agglomeration, the precursor material containing the constituent materials of the granules is compacted and plasticized under pressure and under the effect of shear forces, homogenized and then discharged from the press agglomeration machine via a forming/shaping process. Press agglomeration techniques include extrusion, roller compacting, pelleting, and tableting.

The precursor material containing the constituent materials of the granules can be delivered to a planetary roll extruder or twin screw extruder having co-rotating or contra-rotating screws. The barrel and the extrusion granulation head can be heated to the desired extrusion temperature. The precursor material containing the constituent materials of the granules can be compacted under pressure, plasticized, extruded in the form of strands through a multiple-bore extrusion die in the extruder head, and sized using a cutting blade. The bore diameter of the of extrusion header can be selected to provide for appropriately sized granules. The extruded granules can be shaped using a spheronizer to provide for granules that have a spherical shape.

Optionally, the extrusion and compression steps may be carried out in a low-pressure extruder, such as a flat die pelleting press, for example as available from Amandus Kahl, Reinbek, Germany Optionally, the extrusion and compression steps may be carried out in a low pressure extruder, such as a BEXTRUDER, available from Hosokawa Alpine Aktiengesellschaft, Augsburg, Germany.

The granules can be made using roller compacting. In roller compacting the precursor material containing the constituent materials of the granules is introduced between two rollers and rolled under pressure between the two rollers to form a sheet of compactate. The rollers provide a high linear pressure on the precursor material. The rollers can be heated or cooled as desired, depending on the processing characteristics of the precursor material. The sheet of compactate is broken up into small pieces by cutting. The small pieces can be further shaped, for example by using a spheronizer.

With the granules contained in the laundry composition being produced, the laundry composition of the present invention can be consequently produced by further step of mixing the granules and the fine particles having an average particle size of from 0.1 μm to 15 μm. The mixing step can be conducted by spray-on process, or blending and agitation process, or any other suitable process for mixing solid materials. The amount of fine particles can be 0.1% to 10% of the total weight of the laundry composition. The fine particle with specifically small size will coating on, at least partially of, preferably substantially entire of, the surface of the granules. I.e., the laundry composition of the present invention can be described in a way as a core-coating particulate, where the coating is made of fine particles and the coating may not homogenously coated on entire surface of the core particles.

### Test 1: Granule Aspect Ratio

For non-spherical granules, the longest dimension and shortest dimension can be measured by using Vernier calipers. To reduce the variation of the data, typically 10 granules can be measured and then use the average result. The granule aspect ratio herein is calculated by using this formula: Aspect ratio=Longest dimension/Shortest dimension.

### Test 2: Dissolution Rate Test

The Dissolution Rate Test is used to measure the speed of dissolution of the particulate composition. This test is conducted by adding 400 ml of de-ionized water into a 400 ml transparent glass beaker at room temperature (25° C.), then dispersing about 1 gram of test compositions into the deionized water. Use stop watch to count the total time needed before the compositions are fully dissolved.

### EXAMPLES

The Examples herein are meant to exemplify the present invention but are not used to limit or otherwise define the scope of the present invention.

### Example 1: Flowability Test

The flowability of inventive compositions containing a plurality of granules and a plurality of fine particles (Examples B, C, E, and F) vs. comparative compositions containing no fine particles (Examples A and D), as listed in Table 1 below, are tested and compared. Weigh a desire amount of granules examples (Beads D: Downy Moonlight Breeze beads, Bead R: REWO 9203 beads) in a zip-lock bag, then a desire amount of Zeolite A (from Aluminum Corporation of China Limited Shangdong Branch) is weighed and added into the bag. Manual mix and homogenize the granules and Zeolite for 30 seconds by shaking the bag.

TABLE 1
Exemplary compositions

| | Beads | Beads | Zeolite | Zeolite |
|---|---|---|---|---|
| Examples | D*/g | R\hat{ }/g | A/g | A/% |
| A | 170.00 | — | 0 | 0 |
| B | 170.01 | — | 1.03 | 0.6% |
| C | 170.00 | — | 5.27 | 3.0% |
| D | 85.00 | 85.00 | 0 | 0 |
| E | 85.01 | 85.00 | 1.03 | 0.6% |
| F | 85.02 | 85.01 | 5.27 | 3.0% |

*Beads D: Downy Moonlight Breeze Beads, containing 88.7% PEG9000, 0.12% of a sodium bisulfite solution (40% active), 7.3% perfume (Funky Berry CS2016C J2), 3.86% PMC, and 0.02% dye (LIQUITINT VIOLET BL).
\hat{ } Beads R: REWO 9230 beads (from Evonik), containing 77% PEG9000, 3% cationic HEC, and 20% quaternary ammonium compound.

The resulted compositions are transferred into a bottle which is the same bottle as commercially available Downy Shrek Moonlight Breeze beads (150 g) in China mainland. The resulted composition is then conditioned in 40° C. or 50° C. in the oven for 24 hrs. Pour the composition out immediately after taking it out of the oven, while the product is still maintained at the conditioned temperature. Virtually assessment is conducted by trained lab specialist regarding the flowability by using the following grading:
1—Good Flow (+++);
2—Slow Flow (+) (slightly sticky);
3—Bad Flow (−) (very sticky);
4—No Flow (−−−).

Count the number of particles left in the bottle (stick to bottle wall or lump together). Weighed the product left in the bottle. The test is conducted twice, and the average results are calculated and recorded in Table 2 below.

TABLE 2

| | | Number of | | Numberof |
|---|---|---|---|---|
| | Flowability | particles left | Flowability | particles left |
| | grade after | in bottle | grade after | in bottle |
| | 40° C. | after 40° C. | 50° C. | after 50° C. |
| Examples | conditioned | conditioned | conditioned | conditioned |
| A | +++ | 110.5 | −−− | >3000 |
| B | +++ | 0 | + | 26.5 |
| C | +++ | 0 | + | 9 |
| D | + | 79 | −−− | 340 |
| E | + | 40.5 | − | 135 |
| F | + | 9 | − | 83.5 |

The results in Table 2 show that, when a certain amount of fine particles (Zeolite) is added into the particulate composition of the present invention, the flowability improves even after conditioned at 40° C. or 50° C. in comparison with the same particulate composition but without any fine particles added. Specifically, Examples B and C which contain 0.6% and 3% of zeolite respectively, show much better flowability in comparison with Example A contains no zeolite, the latter is observed having over a hundred of particles left in bottle after conditioned at 40° C., and almost all particles stuck together after conditioned at 50° C. Regarding the Examples of mixture beads (example D, E, &F), improved flowability is also observed by addition of zeolite A.

### Example 2: Fine Particles Residue Test

The inventive and comparative compositions from Example 1 are further tested. First, prepare a pan and a Standard Test Sieve (Tyler No. 70) by cleaning and drying before each test. Pre-weigh the sieve and pan. Weigh 300 g of granules examples (Bead D, or 1:1 mixture of Bead D:Bead R) in a zip-lock bag. A desire amount of Zeolite A (from Aluminum Corporation of China Limited Shangdong Branch) is weighed and added into the bag, to constitute Examples A′-F′, the same concentration as the Examples A-F. Manually mix and homogenize the granules and Zeolite for 30 seconds by shaking the bag. The resulted composition is transferred on the sieve. Sieve the beads with 1.35 mm/“g” amplitude for 60 seconds, with Vibrating Sieve Shaker (Retsch AS 200), and the residue is collected by the pan pre-weighted. Weigh the mass increase of the pan and calculate the residue level (residue level=mass of the residue/the mass of added fine particle (Zeolite A). The test is conducted twice, and the average results are calculated and recorded in Table 3 below.

TABLE 3
Fine Particle Residue level of the
Exemplary Compositions

| | | | | | Sieved | |
|---|---|---|---|---|---|---|
| | | | | | Residue | |
| | | Components | | | of | |
| Exam- | Zeolite | Beads | Beads | Zeolite | Zeolite | Residue |
| ples | A/% | D*/g | R\hat{ }/g | A/g | A/g | level |
| A′ | 0 | 300.00 | | 0 | | N/A |
| B′ | 0.6% | 300.01 | | 1.81 | 0.015 | 0.83% |
| C′ | 3.0% | 300.01 | | 9.28 | 3.802 | 40.9% |
| D′ | 0 | 150.01 | 150.00 | 0 | | N/A |
| E′ | 0.6% | 150.01 | 150.01 | 1.81 | 0.005 | 0.27% |
| F′ | 3.0% | 150.02 | 150.01 | 9.28 | 1.866 | 20.11% |

The results in Table 3 shows that, with specific amount of fine particles added into the composition, the fine particles would coat/stick onto the plurality of granules in the composition of the present invention so that little or no residue of fine particles is detected.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A laundry composition comprising:
a plurality of granules, wherein each of said granules has a longest dimension of no less than 3 mm and no more than 12 mm, and an aspect ratio of no more than 5, and wherein each of said granules has a mass from 1 mg to 1 g; wherein said granules comprise 25% to 99.9% of a water-soluble carrier by weight of the granules; and
from 0.1% to 10% of a plurality of fine particles, by weight of the laundry composition, said fine particles having an average particle size of 0.05 μm to 50 μm.

2. The composition according to claim 1, wherein each of said granules has a regular shape selected from the group consisting of spherical, hemispherical, compressed hemispherical, cylindrical, disc, circular, lentil-shaped, oblong, cubical, rectangular, star-shaped, flower-shaped, and combinations thereof.

3. The composition according to claim 1, wherein the water-soluble carrier comprises a material selected from the group consisting of polyethylene glycol, sodium acetate, sodium bicarbonate, sodium chloride, sodium silicate, polypropylene glycol polyoxoalkylene, polyethylene glycol fatty acid ester, polyethylene glycol ether, sodium sulfate, starch, and combinations thereof.

4. The composition according to claim 1, wherein said water-soluble carrier is a polyethylene glycol having a weight average molecular weight (Mw) from 2,000 to 20,000 Daltons.

5. The composition according to claim 1, wherein the fine particles have an average particle size of from 0.1 μm to 15 μm.

6. The composition according to claim 1, wherein the fine particles comprise a material selected from the group consisting of zeolite, fume silica, precipitated silica, calcium carbonate, titanium dioxide, magnesium carbonate, clays, kaolins, calcium stearate, magnesium stearate, starch and the combinations thereof.

7. The composition according to claim 1, wherein the fine particles are present in an amount of from 0.1% to 5%, by weight of the composition.

8. The composition according to claim 1, wherein said granules further comprise from 0.1% to 25%, by weight of the granules, of a perfume ingredient selected from free perfumes, pro-perfumes, encapsulated perfumes, perfume microcapsules, and combinations thereof.

9. The composition according to claim 1, wherein said granules further comprise from 0.2% to 45%, of a quaternary ammonium compound, by weight of the granules; wherein the quaternary ammonium compound is an ester quaternary ammonium compound.

10. The composition according to claim 1, wherein said granules further comprise from 0.1% to 10%, of a cationic polymer, by weight of the granules; wherein the cationic polymer is cationic polysaccharide.

11. The composition according to claim 1, wherein said granules further comprise from 0.01% to 3%, of diphenyl ether anti-microbial agent by weight of said granules; wherein said diphenyl ether anti-microbial agent is selected from the group consisting of 4-4′-dichloro-2-hydroxy diphenyl ether, 2,4,4′-trichloro-2′-hydroxy diphenyl ether, and a combination thereof.

12. The composition according to claim 1, wherein said granules further comprise other active ingredients selected from the group consisting of surfactants, enzymes, colorants, fatty acid, anti-microbial agent and combinations thereof.

13. A laundry composition comprising:
(i) from 10% to 90% of a plurality of first granules by weight of the laundry composition, wherein each of said first granules has a hemispherical or compressed hemispherical shape, wherein each of said first granules has a longest dimension of no less than 3 mm and no more than 12 mm, and an aspect ratio of no more than 5;
wherein said first granules comprise:
from 25% to 99.9%, by weight of the first granules, of a polyethylene glycol having a weight average molecular weight from 3,000 to 13,000 Daltons; and
from 0.1% to 25%, by weight of the granules, of a perfume ingredient selected from free perfumes, pro-perfumes, encapsulated perfumes, perfume microcapsules, and combinations thereof;
(ii) from 10% to 90% of a plurality of second granules by weight of the laundry composition, wherein each of said second granules has a hemispherical or compressed hemispherical shape, wherein each of said second granules has a longest dimension of no less than 3 mm and no more than 12 mm, and an aspect ratio of no more than 5;
wherein said second granules comprise:
from 25% to 99.9%, by weight of the second granules, of a polyethylene glycol having a weight average molecular weight from 3,000 to 13,000 Daltons,
from 0.5% to 40%, by weight of the second granules, of an ester quaternary ammonium compound; and
from 0.2% to 5%, by weight of the second granules, of a cationic polysaccharide; and
(iii) from 0.1% to 10% of a plurality of fine particles by weight of the laundry composition, said fine particles having an average particle size of from 0.1 μm to 15 μm, wherein said fine particles are selected from the group consisting of zeolite, fume silica, precipitated silica, calcium carbonate, titanium dioxide, magnesium carbonate, clays, kaolins, calcium stearate, magnesium stearate, starch, and combinations thereof.

14. A method of making a laundry composition, comprising the step of:
a. providing a viscous material comprising from 40% to 99% by weight of the composition of polyethylene glycol, wherein said polyethylene glycol has a weight average molecular weight from 3,000 to 13,000 Daltons,
b. passing said viscous material through small openings and onto a moving conveyor surface upon which said viscous material is cooled to form a plurality of granules, and
c. mixing the plurality of granules with a plurality of fine particles having an average particle size of from 0.1 μm to 15 μm, to form said laundry composition.
